(19) United States
(12) Patent Application Publication
(10) Pub. No.: US 2007/0134540 A1
(43) Pub. Date: Jun. 14, 2007

(54) SOLID OXIDE ELECTROCHEMICAL DEVICES HAVING A DIMENSIONALLY STABLE BONDING AGENT TO BOND AN ANODE TO ANODE INTERCONNECT AND METHODS

(75) Inventors: Atul Kumar Verma, Irvine, CA (US); Shekhar Shripad Kamat, Redondo Beach, CA (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schenectady, NY (US)

(21) Appl. No.: 11/164,941

(22) Filed: Dec. 12, 2005

(51) Int. Cl. H01M 2/08; H01M 8/12

(52) U.S. Cl. 429/36; 429/32

(57) ABSTRACT

A solid oxide electrochemical device having improved mechanical integrity comprising a bonding agent for physically and electrically bonding an anode to an anode interconnect, the bonding agent comprising a particulate metal, wherein the bonding agent is substantially chemically inert during operation of the solid oxide electrochemical device. A method for bonding an anode and an anode interconnect to be used in a solid oxide electrochemical device.

### TECHNICAL FIELD

This invention relates to solid oxide electrochemical devices. In particular, this invention relates to solid oxide electrochemical devices having a dimensionally stable bonding agent that electrically and physically bonds an anode to an anode interconnect.

### BACKGROUND OF THE INVENTION

Solid oxide electrochemical devices have demonstrated great potential for future power generation with high efficiency and low emission. Such solid oxide electrochemical devices include solid oxide fuel cells (SOFCs) and solid oxide electrolyzers.

In a solid oxide electrochemical device, stacks of repeatable modular assemblies, each of which is capable of generating a small amount of power, are connected together. Each stack unit is connected to its neighboring unit with an interconnect module, which serves as both a current collector and a channel for flowing gases to the electrodes. Typically, one interconnect unit is connected to the anode side of one fuel cell on one face and the cathode side of the neighboring fuel cell on its other face. As the stacks are built up, there needs to be a mechanical and electrical bond between the interconnect and the electrodes.

This bonding of the interconnect to the electrodes in a solid oxide electrochemical device stack has several requirements. First, the bonding agent and the interfaces formed between the bonding agent and the stack components need to be electrically conductive. Second, the strength of the bond should withstand operational and thermal cycling stresses. Third, the bonding agent and any new compound formed with the introduction of the bonding agent should be chemically compatible with the other fuel cell components and remain stable during operation. Fourth, for structural as well as functional reasons, the bonding agent should remain dimensionally stable during solid oxide electrochemical device start-up and operation.

At present, compressive bonding, in combination with, or as an alternative to, application of the bonding materials in the form of pastes (i.e. carried in an organic vehicle) has been practiced to achieve the bonding between components of solid oxide electrochemical devices. However, the ceramic components in solid oxide electrochemical device stacks are brittle in nature and cannot sustain large compressive forces. In addition, components of a solid oxide electrochemical stack undergo dimensional changes due to bonding agent shrinkage during heat up, when organics burn off, and during operation of the device, when a reducing agent, which is typically gaseous, may be introduced.

In current solid oxide electrochemical device designs, nickel oxide has been the preferred material for use as a bonding agent to connect an anode to an anode interconnect because it is chemically compatible with many device anodes. By using nickel oxide as the bonding agent, shrinkage and dimensional changes occur during stack assembly heat up, when the organics in the bonding agent burn out. Additional shrinkage of the bonding agent occurs when the nickel oxide reduces in the gaseous fuel that is introduced to the solid oxide electrochemical device during operation. This shrinkage leads to uneven movement of the different parts of the stack and causes stresses on the solid oxide electrochemical device. These stresses can cause structural failure or delaminations, which could affect device performance.

### SUMMARY OF THE INVENTION

This invention provides an electrically conductive bonding agent for physically and electrically bonding an anode to an anode interconnect, wherein the bonding agent is chemically inert during operation of the solid oxide electrochemical device. The bonding agent comprises a particulate metal. As used herein, “metal” refers to a metal at a zero valence state, which excludes, for example, metal oxide. Because the particulate metal is already in a reduced state, it does not undergo reduction in a reducing environment within a solid oxide electrochemical device and therefore does not undergo reduction shrinkage.

More particularly, this invention also encompasses a solid oxide electrochemical device with improved mechanical integrity comprising the above-described bonding agent, an anode, an anode interconnect, a cathode, electrolyte disposed between the anode and cathode, a cathode current collector, an anode current collector, and a cathode interconnect. The cathode, anode and electrolyte are disposed between the cathode current collector and the anode current collector. The cathode interconnect electrically connects the cathode to the cathode current collector and the anode interconnect electrically connects the anode to the anode current collector. The bonding agent physically and electrically bonds the anode to the anode interconnect.

In addition, this invention encompasses a method for mechanically and physically bonding an anode and an anode interconnect to be used in a solid oxide electrochemical device comprising applying a bonding agent comprising a vehicle and a particulate metal dispersed in the vehicle between the anode and the anode interconnect so that the bonding agent is in contact with the anode and the anode interconnect, heating the anode, bonding agent, and anode interconnect in a gaseous environment containing an oxidizing agent to a first temperature effective to burn off the vehicle from the bonding agent, introducing the anode, bonding agent, and anode interconnect at a second temperature to a gaseous environment containing a reducing agent to reduce oxides which formed in the gaseous environment containing the oxidizing agent, wherein the second temperature is equal to or greater than the first temperature, and heating the anode, bonding agent, and anode interconnect to a third temperature to bond the bonding agent to the anode and the anode interconnect in-situ, wherein the third temperature is equal to or greater than the second temperature.

Other objects, features, and advantages of this invention will be apparent from the following detailed description, drawing, and claims.

### BRIEF DESCRIPTION OF DRAWINGS

FIG. 1 is an exploded perspective view of a solid oxide electrochemical device made in accordance with an embodiment of the present invention.

FIG. 2 is a schematic illustration of the solid oxide electrochemical device of FIG. 1 in operation.

FIG. 3 is a schematic illustration of the application of an embodiment of the present invention to a metal plate and a ceramic plate that will be placed on the embodiment of the present invention for shrinkage testing.

FIG. 4 is an image of the surface profile of a sample using a prior art nickel oxide bonding agent used in determining shrinkage results.

FIG. 5 is an image of the surface profile a sample using a bonding agent made in accordance with an embodiment of the present invention used in determining shrinkage results.

### DETAILED DESCRIPTION OF EMBODIMENTS

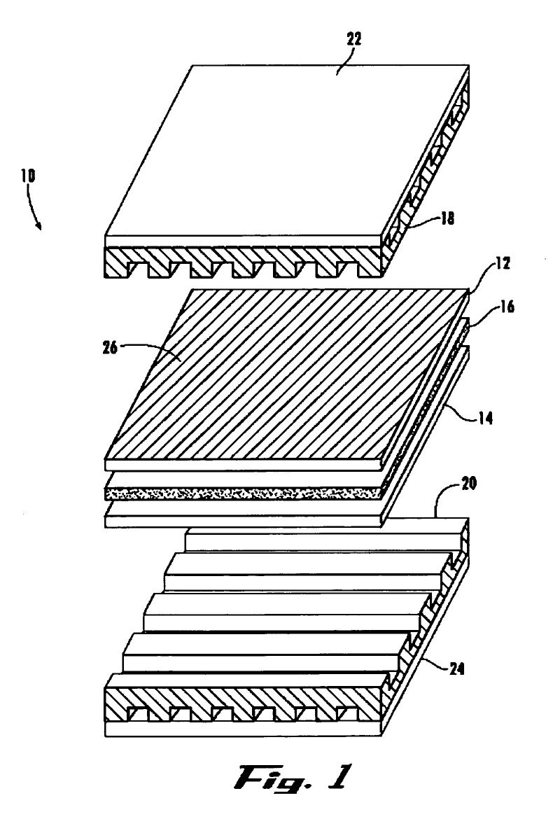

As summarized above, this invention encompasses a bonding agent for physically and electrically bonding an anode to an anode interconnect, a solid oxide electrochemical device including such bonding agent, and a method for mechanically and physically bonding an anode and an anode interconnect using such bonding agent. Embodiments of this invention are described in detail below and illustrated in FIGS. 1-3. A single solid oxide electrochemical device 10 having improved mechanical integrity made in accordance with an embodiment of this invention is illustrated in FIG. 1. More particularly, the solid oxide electrochemical device 10 in FIG. 1 is a SOFC, but it should be understood that this invention also encompasses solid oxide electrolyzers. Generally, the solid oxide electrochemical device 10 comprises an anode 12, a cathode 14, solid electrolyte 16 disposed between the anode 12 and the cathode 14, an anode interconnect 18, a cathode interconnect 20, an anode current collector 22, and an cathode current collector 24.

The anode 12 is in the form of a thin ceramic layer and is suitable for solid oxide electrochemical device operation. Desirably, the anode 14 comprises a nickel-yttria-stabilized zirconia (YSZ)—cermet, which is derived from a nickel oxide and yttria-stabilized zirconia (YSZ) composite. Such anodes are well known to those skilled in the art. The cathode 14 is also in the form of a ceramic plate and is also suitable for solid oxide electrochemical device operation. It is desirably made of lanthanum strontium manganite (LSM), lanthanum strontium ferrite (LSF), and cobaltites, while the foregoing anode 12 and cathode 14 materials are preferred, it should be understood that other anode and cathode materials may be used provided they are compatible with the bonding agent 26.

The electrolyte 16 is disposed between the anode 12 and the cathode 14 and is desirably a solid electrolyte made of dense yttria-stabilized zirconia (YSZ) material, although other electrolyte materials can be used. Such electrolyte materials are well known to those skilled in the art.

The anode current collector 22 and the cathode current collector 24 are made of electrically conducting materials such as a metal plate or metal foil. Desirably, the anode current collector 22 and the cathode current collector 24 are made of metals such as SS446 (stainless steel), SS430 (stainless steel), AL453, E-Brite available from Allegheny Ludlum Corporation, Crofer 22 available from ThyssenKrupp VDM, or Fecralloy available from Goodfellow. The anode 12, the cathode 14, and the solid electrolyte 16 are disposed between the anode current collector 22 and the cathode current collector 24 to form a complete solid oxide electrochemical device module as illustrated in FIG. 1, although the solid oxide electrochemical device 10 can take other shapes.

The anode interconnect 18 electrically connects the anode 12 to the anode current collector 22 and spaces the anode from the anode current collector. This forms a flowfield between the anode 12 and the anode current collector 22 for flow of a gas over at least a portion of the anode.

The cathode interconnect 20 electrically connects the cathode 14 to the cathode current collector 24 and also spaces the cathode from the cathode current collector. This forms a flowfield between the cathode 14 and the cathode current collector 24 for gas flow over at least a portion of the cathode. Therefore, at least a portion of the anode 12 and at least a portion of the cathode 14 remain unobstructed by the respective interconnects 18 and 20.

The anode and cathode interconnects 18 and 20 are made of electrically conductive material and desirably made of metal plate or foil. More desirably, the anode and cathode interconnects 18 and 20 are made of high temperature stainless steel such as SS446, SS430, AL453, E-Brite, Crofer 22, or Fecralloy.

The anode 12 and the anode interconnect 18 are electrically and physically bonded by a bonding agent 26. The bonding agent 26 within the assembled solid oxide electrochemical device 10 is in a “dry” form and comprises no fluids or gels, in contrast to a “wet” form of the bonding agent discussed below in reference to the method of bonding the anode 12 to the anode interconnect 18. The “dry” bonding agent 26 comprises a particulate metal. Zero valent metal is ideally suited for use in the bonding agent 26 because it will not reduce in a solid oxide electrochemical device operating environment, as the metal is already at a zero valence level. This property causes the bonding agent to be substantially chemically inert during operation of the solid oxide electrochemical device 10. As the bonding agent 26 is substantially chemically inert during operation, substantially no shrinkage occurs. Accordingly, stresses between the anode 12 and the anode interconnect 18 are avoided and the solid oxide electrochemical device 10 has an improved mechanical integrity. Examples of suitable particulate metals include, but are not limited to, nickel and cobalt. Nickel is particularly suitable for use with a nickel and yttria-stabilized zirconia (YSZ) composite anode because the nickel in the bonding agent 26 can bond with the anode by diffusion bonding. Desirably, the particulate metal for the bonding agent is selected based on compatibility with the anode material and the overall SOFC environment.

The “dry” bonding agent 26 must electrically connect the anode 12 to the anode interconnect 18 and the bonding agent 26 must contain enough particulate metal to be conductive. In consequence, the particulate metal may be present in the bonding agent 26 in an amount ranging from about 33% to about 100% by volume of the bonding agent. More preferably, the particulate metal may be present in the bonding agent 26 in an amount ranging from about 50% to about 100% by volume of the bonding agent. Still more preferably, the particulate metal may be present in the bonding agent 26 in an amount ranging from about 90% to about 100% by volume of the bonding agent.

The remainder of the “dry” bonding agent 26 may further comprise a particulate filler material that is substantially chemically inert during operation of the solid oxide electrochemical device. This particulate filler material may be a ceramic material. For example, the ceramic material may be yttria-stabilized zirconia (YSZ) or alumina Being chemically inert, the particulate filler material also does not shrink. The particulate filler material may be present in the bonding agent 26 in an amount ranging from about 10% to about 66% by volume of the bonding agent, or more preferably, from about 10% to about 30% by volume of the bonding agent.

To bond the anode 12 and anode interconnect 18 mechanically and physically in the solid oxide electrochemical device 10, the following method may be used. First, a “wet” bonding agent may be applied between the anode 12 and the anode interconnect 18 so that the bonding agent is in contact with the anode 12 and the anode interconnect 18. The step of applying the bonding agent may be accomplished, for example, by screen printing or pneumatic paste dispensing, or any other effective method. Next, the anode 12, bonding agent 26, and anode interconnect 18 are heated in a gaseous environment containing an oxidizing agent to a first temperature effective to burn off the vehicle from the bonding agent. Then, the anode 12, bonding agent 26, and anode interconnect 18 are introduced at a second temperature to a gaseous environment containing a reducing agent to reduce oxides which formed in the gaseous environment containing the oxidizing agent. Furthermore, the anode 12, bonding agent 26, and anode interconnect 18 are heated to a third temperature to bond the bonding agent 26 to the anode 12 and the anode interconnect 18 in-situ.

As applied to the anode 12 and the anode interconnect 18 in the first step of the method of the present invention, the “Wet” bonding agent composition differs from the “dry” bonding agent composition. In an assembled solid oxide electrochemical device, the “dry” bonding agent 26 comprises substantially solids. Prior to the heating step to burn off the vehicle, the bonding agent is in a “wet” form and may comprise solids, liquids, and gels to facilitate application of the bonding agent to the anode and/or anode interconnect. For example, the “wet” bonding agent may be in the form of a paste. After burn off of the vehicle, the bonding agent is in a “dry” form, as all liquids and gels are burned off with the vehicle.

The “Wet” bonding agent comprises a vehicle and a particulate metal dispersed within the vehicle. Consequently, the metal should be in a particulate form so as to be dispersed in the vehicle. The particulate forms may include a power, flakes, or any other granular form. Suitable metals include, but are not limited to, nickel and cobalt.

The vehicle may comprise binders, dispersants, solvents, or combinations thereof. The binders, dispersants, and solvents may be chosen for their compatibility with each other, with the particulate metal, and with the solid oxide electrochemical device as a proper vehicle for the particulate metal. Suitable vehicles include, but are not limited to, organic materials. The organic materials may include a polymeric material. Suitable polymeric materials include polyvinylbutyral (PVB) binders or Heraeus V006, which includes a binder and a dispersant. More specifically, Heraeus V006 comprises an ethyl cellulose resin mixed with a terpineol solvent. Examples of suitable solvents include, but are not limited to, alpha terpineol or other terpineol solvents.

The composition of the “wet” bonding agent, before the heating step to burn off the vehicle, may be such that the particulate metal is present in the bonding agent in an amount ranging from about 20% to about 60% by volume of the bonding agent, or more preferably, from about 30% to about 40% by volume of the bonding agent. The vehicle may be present in bonding agent, before the heating step to burn off the vehicle, in an amount ranging from about 40% to about 80% by volume of the bonding agent, or more preferably, from about 60% to about 70% by volume of the bonding agent.

In addition, the “wet” bonding agent, as applied to the anode and the anode interconnect, and before the heating step to bum off the vehicle, may further comprise a particulate filler material which is substantially chemically inert during operation of the solid oxide electrochemical device. This particulate filler material may be a ceramic material. For example, the ceramic material may be yttria-stabilized zirconia (YSZ) or alumina. The particulate filler material may be present in the bonding agent, before the heating step, in an amount ranging from about 0% to about 20% by volume of the bonding agent, or more preferably, from about 10% to about 15% by volume of the bonding agent.

Heating the anode 12, “wet” bonding agent, and anode interconnect 18, in a gaseous environment containing an oxidizing agent, to a first temperature burns off the vehicle. In embodiments where the vehicle contains organic materials, the heating in a gaseous environment containing an oxidizing agent also results in pyrolysis of substantially all of the organic material. The oxidizing agent may be oxygen, for example, and the gaseous environment may be air, for example. The first temperature can be any temperature high enough to burn off the vehicle. However, the first temperature is preferably below a temperature where substantial amounts of the particulate metal may oxidize in the gaseous environment containing the oxidizing agent. For example, the first temperature may be below about 500° C. when the gaseous environment containing the oxidizing agent is air and the particulate metal in the “wet” bonding agent is nickel. Oxide is undesirable in the bonding agent, as the oxide may reduce in the fuel gas during operation of the solid oxide electrochemical device and cause shrinkage of the bonding agent. Shrinkage of the bonding agent then results in dimensional instability, which increases the likelihood of structural failure or delaminations.

To insure that any oxides of the particulate metal formed in the bonding agent are reduced to a zero valence level state, the anode 12, bonding agent 26, and anode interconnect 18 are introduced to a gaseous environment containing a reducing agent at a second temperature. The reducing agent may be, but is not limited to, hydrogen or any fuel gas. The gaseous environment may be, but is not limited to, a hydrogen and nitrogen gas mixture or a fuel gas mixture. The second temperature may be any temperature at which oxides of the particulate metal reduce to the zero valence state in the presence of the reducing agent. Additionally, the second temperature may be equal to or greater than the first temperate. In some embodiments, the second temperature should be above a temperature at which introduction of the gaseous environment at the second temperature would be unsafe. For example, in an embodiment where the reducing agent is hydrogen, the first temperature should be above 500° C.

To bond the bonding agent to both the anode 12 and the anode interconnect 18, the anode, bonding agent, and anode interconnect are heated to a third temperature equal to or greater than the second temperature. For example, the third temperature may range from about 700° C. to about 1000° C, or more preferably, from about 800° C. to about 900° C. After burning off the vehicle, reducing any oxide in the bonding agent, and bonding the bonding agent to both the anode and anode interconnect, the bonding agent 26 is substantially chemically inert during operation of the solid oxide electrochemical device because the bonding agent 26 is in a “dry” form comprised substantially of solids and experiences minimal shrinkage and improved mechanical stability.

As discussed above, the composition of the “dry” bonding agent comprises particulate metal. In alternate embodiments where the “wet” bonding agent also contains particulate filler material, the “dry” bonding agent may also contain particulate filler material in volume amounts similar to the amounts in the “dry” bonding agent form discussed above.

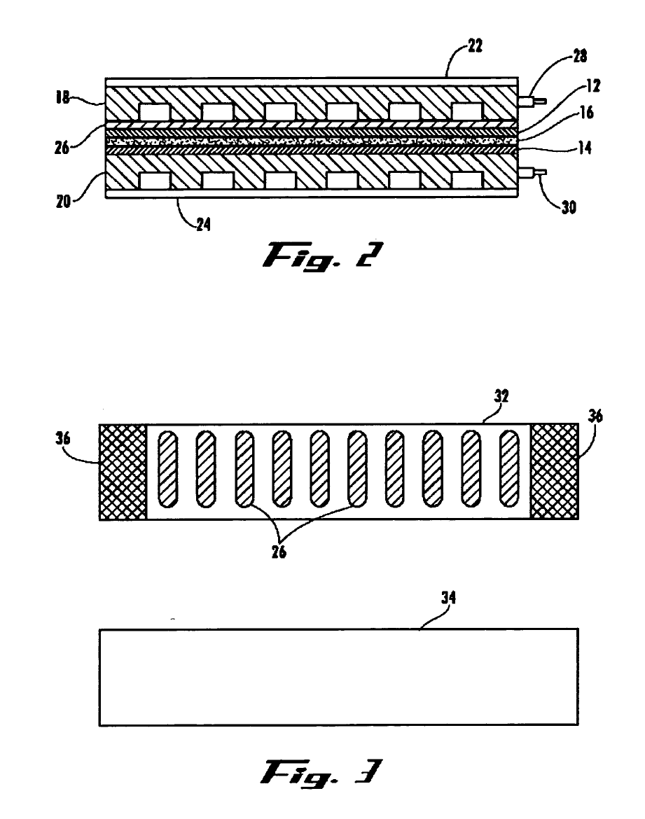

FIG. 2 illustrates the solid oxide electrochemical device of FIG. 1 in operation. In operation, the solid oxide electrochemical device 10 is equipped with an gas inlet 28 for feeding gas along the gas flow path between the anode 12 and the anode current collector 22 and through the anode interconnect 18. The solid oxide electrochemical device 10 is also equipped with another gas inlet 30 for feeding another gas along another flow path between the cathode 14 and the anode current collector 18 and through the cathode interconnect 20. The bonding agent 26 is substantially chemically inert during operation of the solid oxide electrochemical device and thus, there are no dimensional changes in the bonding agent 26. Thus, the bonding agent 26 improves the mechanical integrity of the solid oxide electrochemical device and reduces the likelihood of structural failure or delaminations.

The present invention is further illustrated below in an example which is not to be construed in any way as imposing limitations upon the scope of the invention. On the contrary, it is to be clearly understood that resort may be had to various other embodiments, modifications, and equivalents thereof which, after reading the description therein, may suggest themselves to those skilled in the art without departing from the scope of the invention and the appended claims.

### EXAMPLE 1

In a preferred embodiment of the present invention, a “wet” bonding agent 26 paste is prepared having a vehicle comprising Heraeus V006, which contains both a binder and a dispersant, and an alpha terpineol solvent and a particulate nickel dispersed in the vehicle. The “wet” bonding agent paste further comprises a particulate filler material comprising yttria-stabilized zirconia. The Heraeus V006 is present in the “Wet” bonding agent paste in the amount of 30% by volume of the “wet” bonding agent paste and the alpha terpineol solvent is present in the “wet” bonding agent paste in the amount of 40% by volume of the “wet” bonding agent paste. The particulate nickel is present in the “wet” bonding agent paste in the amount of 27% by volume of the “wet” bonding agent paste. The yttria-stabilized zirconia (YSZ) is present in the “wet” bonding agent paste in the amount of 3% by volume of the “wet” bonding agent paste.

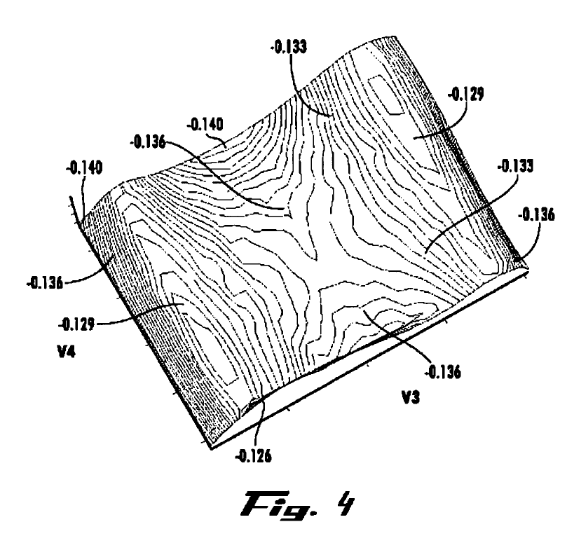

The “wet” bonding agent 26 paste is applied to an E-Brite steel plate 32 in parallel beads along the width of the steel plate. FIG. 3 illustrates this application of the “wet” bonding agent 26 paste to the steel plate 32. The steel plate 32 having the “wet” bonding agent 26 paste is then joined with the anode side of a SOFC ceramic plate 34 so that the “wet” bonding agent paste is in between the steel plate and the ceramic plate. Seal tape 36 is also applied to the ends of the metal plate to hold the steel plate 32 and ceramic plate 34 together before heat up. A dead weight is then placed on the assembled steel plate 32, “wet” bonding agent 26 paste, and ceramic plate 34.

The assembly is then placed in a furnace and heated to burn off the vehicle, reduce any oxides formed in the bonding agent, and bond steel plate 32 to the ceramic plate 34 with the bonding agent 26. The vehicle, including the binder, dispersant, and solvent are burned off by increasing the temperature of the furnace at a rate of about 90° C. to 100° C. per hour to a first temperature of about 500° C. in a gaseous environment comprising air. The assembly is then introduced to a gaseous environment comprising hydrogen in an amount of 3.5% by volume of the gas and nitrogen in an amount of 96.5% by volume of the gas at a second temperature of about 500° C. to reduce any nickel oxide formed in the bonding agent 26. The second temperature is increased at about 90° C. to 100° C. per hour until a third temperature is reached. At this third temperature of about 800° C. to 900° C., the bonding agent 26 is bonded to both the steel plate 32 and the ceramic plate 34. After the processing of the assembly, the bonding agent 26 is in a “dry” form and comprises 90% particulate nickel and 10% yttria-stabilized zirconia (YSZ).

A baseline for comparison was also produced using a prior art nickel oxide bonding agent paste sample is prepared in the same manner. The composition of the nickel oxide bonding agent paste is as follows: A vehicle system comprising Heraeus V006 in the amount of 30% by volume of the “wet” prior art bonding agent paste and an alpha terpineol solvent in the amount of 40% by volume of the prior art bonding agent paste. The nickel oxide is present in the prior art bonding agent paste in the amount of 30% by volume of the bonding agent paste.

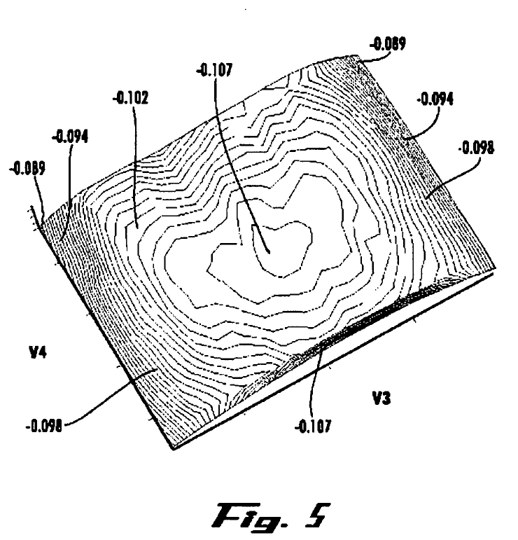

The surface profile of both assemblies are then measured to determine shrinkage using a laser based profilometer. FIG. 4 is an image of the surface profile of the sample made with the prior art nickel oxide bonding agent. FIG. 5 is an image of the surface profile a sample made with the bonding agent 26 made in accordance with an embodiment of the present invention. The absence of shrinkage in the bonding agent 26 can be seen when comparing the FIG. 4 to FIG. 5. FIG. 4 illustrates dimensional irregularity caused by shrinkage of the prior art nickel oxide bonding agent. In contrast, FIG. 5 shows that the bonding agent 26 of the present invention results in a uniform contour because of the absence of shrinkage.

It should be understood that the foregoing relates to particular embodiments of the present invention, and that numerous changes may be made therein without departing from the scope of the invention as defined from the following claims.

What is claimed is:

1. A solid oxide electrochemical device having improved mechanical integrity comprising:
a cathode;
an anode;
electrolyte disposed between the anode and the cathode;
a cathode current collector;
an anode current collector, the cathode, the anode, and electrolyte disposed between the cathode current collector and the anode current collector;
a cathode interconnect electrically connecting the cathode to the cathode current collector;
an anode interconnect electrically connecting the anode to the anode current collector;
an electrically conductive bonding agent for physically and electrically bonding the anode to the anode interconnect, the bonding agent comprising a particulate metal, wherein the bonding agent is substantially chemically inert during operation of the solid oxide electrochemical device.

2. The solid oxide electrochemical device as in claim 1, wherein the particulate metal comprises nickel or cobalt.

3. The solid oxide electrochemical device as in claim 1, wherein the bonding agent further comprises a particulate filler material which is substantially chemically inert during operation of the solid oxide electrochemical device.

4. The solid oxide electrochemical device as in claim 3, wherein the particulate filler material comprises a ceramic material.

5. The solid oxide electrochemical device as in claim 4, wherein the ceramic material is yttria-stabilized zirconia or alumina.

6. The solid oxide electrochemical device as in claim 1, wherein the particulate metal is present in the bonding agent in an amount ranging from about 33% by volume of the bonding agent to about 100% by volume of the bonding agent.

7. The solid oxide electrochemical device as in claim 1, wherein the particulate metal is present in the bonding agent in an amount ranging from about 50% by volume of the bonding agent to about 100% by volume of the bonding agent.

8. The solid oxide electrochemical device as in claim 1, wherein the particulate metal is present in the bonding agent in an amount ranging from about 90% by volume of the bonding agent to about 100% by volume of the bonding agent.

9. The solid oxide electrochemical device as in claim 1, wherein the electrochemical device is a solid oxide fuel cell.

10. The solid oxide electrochemical device as in claim 1, wherein the electrochemical device is a solid oxide electrolyzer.

11. A method for mechanically and physically bonding an anode and an anode interconnect to be used in a solid oxide electrochemical device comprising:
applying a bonding agent between an anode and an anode interconnect so that the bonding agent is in contact with the anode and the anode interconnect, the bonding agent comprising a vehicle and a particulate metal dispersed in the vehicle;
heating the anode, the bonding agent, and the anode interconnect in a gaseous environment containing an oxidizing agent to a first temperature effective to burn off the vehicle from the bonding agent;
introducing the anode, the bonding agent, and the anode interconnect at a second temperature to a gaseous environment containing a reducing agent to reduce oxides which formed in the gaseous environment containing the oxidizing agent, wherein the second temperature is equal to or greater than the first temperature; and
heating the anode, the bonding agent and the anode interconnect to a third temperature to bond the bonding agent to the anode and the anode interconnect in-situ, wherein the third temperature is equal to or greater than the second temperature, and wherein the bonding agent is electrically conductive and substantially chemically inert during operation of the solid oxide electrochemical device.

12. The method of claim 11, wherein the third temperature ranges from about 700° C. to about 1000° C.

13. The method of claim 11, wherein the third temperature ranges from about 800° C. to about 900° C.

14. The method of claim 11, wherein the oxidizing agent is oxygen.

15. The method of claim 11, wherein the first temperature is less than about 500° C.

16. The method of claim 11, wherein the reducing agent is hydrogen.

17. The method of claim 16, wherein the gaseous environment containing a reducing agent contains hydrogen an amount of about 3% to about 100% hydrogen by volume of the gaseous environment.

18. The method of claim 11, wherein the second temperature is greater than about 500° C.

19. The method of claim 11, wherein the step of applying the bonding agent comprises screen printing or pneumatic paste dispensing the bonding agent.

20. The method of claim 11, wherein the particulate metal comprises nickel or cobalt.

21. The method of claim 11, wherein the vehicle, before the step of heating the anode, the bonding agent, and the anode interconnect in a gaseous environment containing an oxidizing agent, comprises an organic material and the step of heating the anode, the bonding agent, and the anode interconnect in a gaseous environment containing an oxidizing agent carbonizes substantially all of the organic material.

22. The method of in claim 21, wherein the organic material comprises a polymeric material.

23. The method of claim 21, wherein the polymeric material is polyvinylbutyral or an ethyl cellulose.

24. The method of claim 11, wherein the bonding agent further comprises a particulate filler material which is substantially chemically inert during operation of the solid oxide electrochemical device.

25. The method of claim 24, wherein the particulate filler material comprises a ceramic material.

26. The method of claim 25, wherein the ceramic material is yttria-stabilized zirconia or alumina.

27. The method of claim 11, wherein the particulate metal is present in the bonding agent, before the step of heating the anode, the bonding agent, and the anode interconnect in a gaseous environment containing an oxidizing agent, in an amount ranging from about 20% by volume of the bonding agent to about 60% by volume of the bonding agent.

28. The method of claim 11, wherein the particulate metal is present in the bonding agent, before the step of heating the anode, the bonding agent, and the anode interconnect in a gaseous environment containing an oxidizing agent, in an amount ranging from about 30% by volume of the bonding agent to about 40% by volume of the bonding agent.

29. The method of claim 11, wherein the vehicle, before the step of heating the anode, the bonding agent, and the anode interconnect in a gaseous environment containing an oxidizing agent, comprises a binder, a dispersant, a solvent, or combinations thereof.

30. The method of claim 29, wherein the bonding agent further comprises a particulate filler material which is substantially chemically inert during operation of the solid oxide electrochemical device.
